(19) United States
(12) Patent Application Publication
(10) Pub. No.: US 2012/0079320 A1
(43) Pub. Date: Mar. 29, 2012

(54) SYSTEM AND METHOD FOR PERFORMING A MIRROR SET BASED MEDIUM ERROR HANDLING DURING A CONSISTENCY CHECK OPERATION ON A RAID 1E DISK ARRAY

(76) Inventor: NAVEEN KRISHNAMURTHY, Bangalore (IN)

(21) Appl. No.: 12/891,821

(22) Filed: Sep. 28, 2010

(51) Int. Cl. G06F 11/16

(52) U.S. Cl. 714/6.23; 714/E11.062; 711/114

(57) ABSTRACT

A system and method for performing a mirror set based error handling during a consistency check operation on a RAID 1E disk array is disclosed. In one embodiment, in a method for performing a mirror set based medium error handling during a consistency check (CC) operation on a RAID 1E disk array, a read operation is performed on a current row. The RAID 1E disk array is formed using mirror sets having rows, where each mirror set includes a pair of disks, and the rows include at least one block in each of the pair of disks. A list of all medium errors found in the current row is formed. The medium errors found in the current row are grouped on mirror set basis and the medium errors that do not have a corresponding medium error in substantially same block in other disk in a mirror set are recovered.

### BACKGROUND

Consistency check (CC) is a mechanism or operation used in a redundant array of independent disks (RAID) firmware to verify whether all rows in a disk array associated with a redundant RAID level are consistent. In RAID 1, the data is mirrored when an inconsistent row is detected during a CC operation. In RAID 5 and RAID 6, parity data is recreated from peer drives during the CC operation. The CC operation may also include variant implementations and secondary RAID levels based on RAID 1, RAID 5 and RAID 6 and RAID 10, RAID 50, RAID 60.

Typically, two basic functions are performed during a CC cycle. The first one includes performing a read operation and the second one includes performing XOR operation on the read data to validate consistency. To perform the read operation, read requests are sent to all disks forming the disk array. RAID 1E disk array (also known as PRL 11) has been implemented in the RAID firmware as an extension of RAID 1 disk array. RAID 1E disk array can be considered as a collection of multiple RAID 1 disk arrays, where each RAID 1 disk array in the RAID 1E disk array is referred to as a mirror set.

During a CC operation on the RAID 1E disk array, a read operation is performed on all the mirror sets or physical arms in a row. Then, an XOR operation is performed on each mirror set to check whether the data is consistent with parity or mirror. The medium errors found during the read operation are not handled during the XOR operation of the RAID IE disk array. Existing techniques to handle medium errors in RAID 1 disk array cannot be extended to the RAID IE disk array, since the RAID 1 disk array includes only one mirror set while the RAID 1E includes multiple independent mirror sets.

### BRIEF DESCRIPTION OF THE DRAWINGS

Various embodiments are described herein with reference to the drawings, wherein:

FIG. 1 illustrates a flow diagram of an exemplary method for performing a mirror set based medium error handling during a consistency check (CC) operation on a redundant array of independent disks (RAID) 1E disk array, according to one embodiment;

FIG. 2A illustrates an exemplary spanned RAID1E disk array implementing the mirror set based medium error handling described in FIG. 1, according to one embodiment;

FIG. 2B illustrates an exemplary non-spanned RAID 1E disk array implementing the mirror set based medium error handling described in FIG. 1, according to one embodiment; and

FIG. 3 illustrates an exemplary storage system for implementing embodiments of the present subject matter.

The drawings described herein are for illustration purposes only and are not intended to limit the scope of the present disclosure in any way.

### DETAILED DESCRIPTION

A system and method for performing mirror set based medium error handling during a consistency check operation on a RAID 1E disk array is disclosed. In the following detailed description of the embodiments of the present subject matter, reference is made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

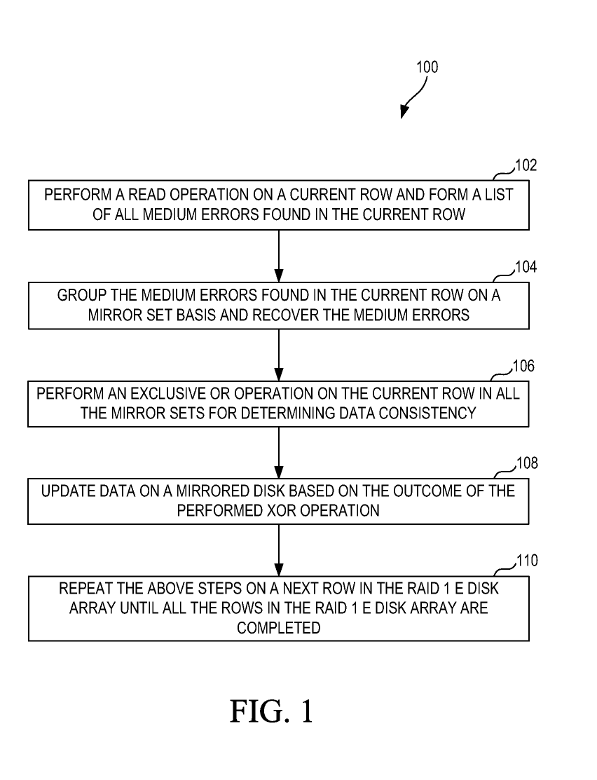

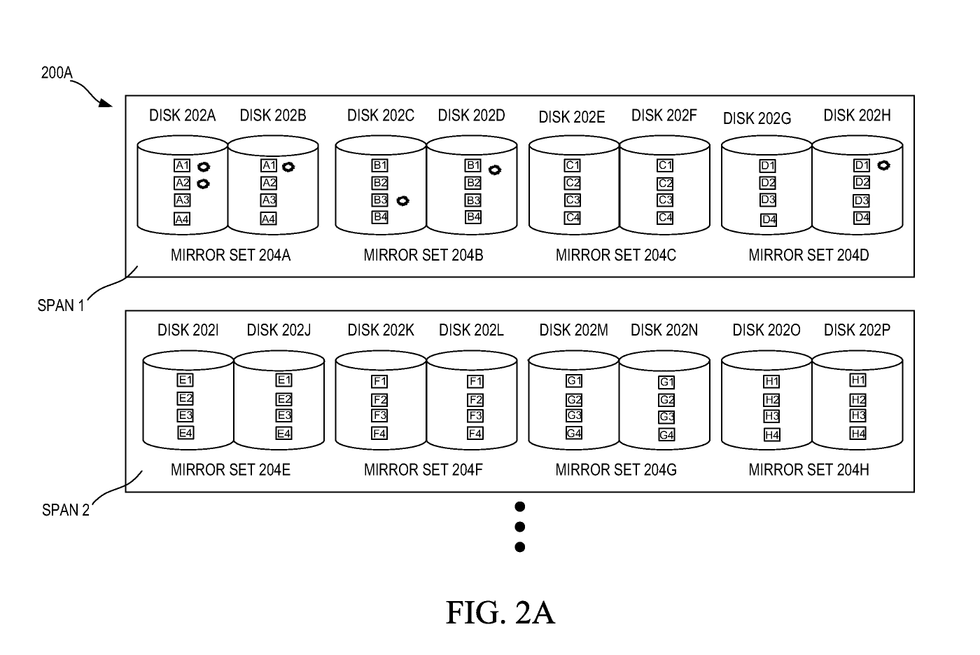

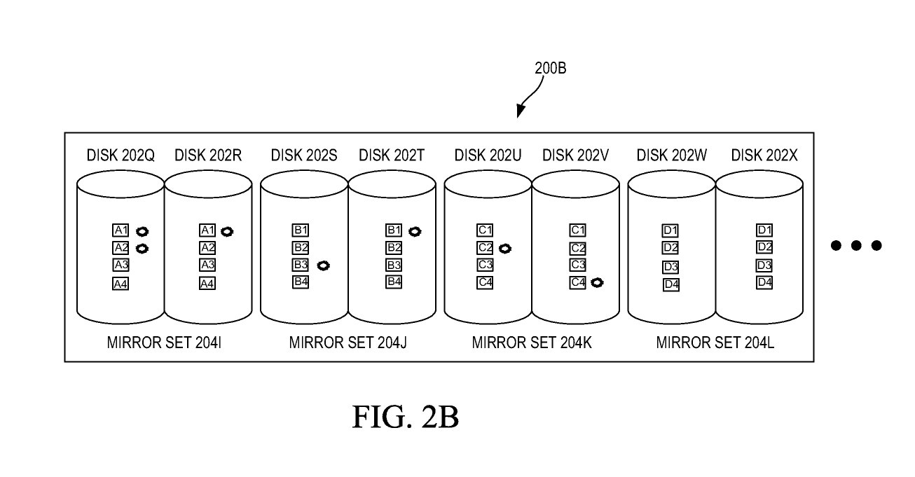

FIG. 1 illustrates a flow diagram 100 of an exemplary method for performing a mirror set based medium error handling during a consistency check (CC) operation on a redundant array of independent disks (RAID) 1E disk array, according to one embodiment. The RAID 1E disk array is an extension of RAID 1 disk array and includes multiple RAID 1 disk arrays, where each RAID 1 disk array forms a mirror set. Thus, the RAID 1E disk array includes a plurality of mirror sets (e.g., the mirror sets 204A-H of FIG. 2A) which are independent of each other.

Each of the mirror sets includes a pair of disks. In each of the pair of disks, one disk is the mirror of other disk and is referred to as a mirrored disk. Further, each of the disks in the all the mirror sets in the RAID 1E disk array is divided into a plurality of rows. Each row may be formed using at least one data block (e.g., of 512 bytes) of each disk, where the data block stores data. The RAID 1E disk array may be a spanned RAID 1E disk array (e.g., as shown in FIG. 2A) or a non-spanned RAID 1E disk array (e.g., as shown in FIG. 2B).

At step 102, a read operation is performed on a current row and a list of all medium errors found in the current row during the read operation is formed. For example, the read operation is performed during a first phase of the CC operation. At step 104, the medium errors found in the current row are grouped on a mirror set basis and the medium errors that do not have a corresponding medium error in a substantially same block in other disk in a mirror set are recovered during a second phase of the CC operation. In one example embodiment, one or more medium errors associated with a current mirror set are determined from the list of medium errors found in the current row. Then, the determined one or more medium errors for the current mirror set in the current row are recovered. The steps of determining and recovering are repeated for a next mirror set in the current row of the RAID 1E disk array.

At step 106, an exclusive -OR (XOR) operation is performed on the current row in all the mirror sets for determining data consistency between the pair of disks in each of the plurality of mirror sets. At step 108, data on a mirrored disk in the plurality of mirror sets is updated based on the outcome of the performed XOR operation. In one example embodiment, during the XOR operation, if it is found that data is not consistent in a current mirror set, then data on the mirrored disk is updated using other disk in the current mirror set. In another example embodiment, if the data is consistent in the current mirror set, then it is determined to see whether a next mirror set is available in the RAID 1E disk array that requires performing the XOR operation to determine data consistency.

Further, an XOR operation is performed on the next mirror set. If there are no more mirror sets in the current row in the RAID 1E disk array, then the CC operation on the current row is completed. At step 110, the steps of performing the read operation, grouping the medium errors, recovering the medium errors, performing the XOR and updating are repeated on a next row in the RAID 1E disk array until all the rows in the RAID 1E disk array are completed. The above-described mirror set based error handling may be also performed during a CC operation on a degraded RAID IE disk array.

FIG. 2A illustrates an exemplary spanned RAID 1E disk array 200A implementing the mirror set based medium error handling described in FIG. 1, according to one embodiment. As illustrated, the spanned RAID 1E disk array 200A includes 2 spans, each span having 4 independent mirror sets. The number of spans may extend up to 8 spans in the spanned RAID 1E disk array 200A. In FIG. 2A, the span 1 includes mirror sets 204A-D and the span 2 includes mirror sets 204E-H. Each of the mirror sets 204A-H includes a pair of disks. For example, the mirror set 204A includes disks 202A and 202B, where the disk 202B is a mirrored disk. Each of the disks 202A-P includes data blocks (e.g., data blocks A1-A4 in the disk 202A). Further, as shown, there are three medium errors on the mirror set 204A, two medium errors on the mirror set 204B, no medium errors in the mirror set 204C and one medium error on the mirror set 204D of span 1.

During a first phase of a CC operation on the spanned RAID 1E disk array 200A, a read operation is performed on a first row. As shown in FIG. 2A, the first row is formed using data blocks A1-A4 of the mirror set 204A, data blocks B1-B4 of the mirror set 204B, data blocks C1-C4 of the mirror set 204C and data blocks D1-D4 of the mirror set 204D. During the read operation, the medium errors on the mirror sets 204A-D in the first row are found and are collected in a medium error table A. The read operation in each of the disks 202A-P may not complete on a disk by disk basis. For example, the read operation may be completed in an order: disk 202B, 202C, 202A, 202D, and 202H. Hence, the medium error table A displaying medium error entries found at different data blocks of the disks 202A-H of the span 1 will be as follows.

MEDIUM ERROR TABLE A

| DISK | DATA BLOCK |
|---|---|
| 202B | A1 |
| 202C | B3 |
| 202A | A1, A2 |
| 202D | B1 |
| 202H | D1 |

Then, an XOR is performed on the mirror set 204A during a second phase of the CC operation. According to an embodiment of the present subject matter, during the second phase, it is determined whether there are any medium errors belonging to the mirror set 204A from the medium error table A. For example, the medium error table A is searched starting from its first entry to find the medium errors belonging to the mirror set 204A. If the first entry does not belong to the mirror set 204A, then the first entry is pushed back to the medium error table A. Similarly, it is determined whether a second entry belongs to the mirror set 204A. If the second entry also does not belong to the mirror set 204A, then the second entry is pushed back to the medium error table A. As shown, a third entry in the medium error table A indicates a presence of a medium error in the disk 202A of the mirror set 204A at data block A1.

Further, it is determined whether there is a medium error in a substantially same block in other disk of the mirror set 204A. That is, it is determined from the medium error table A whether there is a medium error entry for data block A1 of the disk 202B. If the medium error entry is found for the data block A1 in the disk 202B, then the medium errors in the mirror set 204A become unrecoverable. This is because of the presence of the medium errors at same data block of the disk 202A and the disk 202B in the mirror set 204A. The medium error entries for the data block A1 in the disk 202A and the disk 202B are deleted from the medium error table A. Further, all other entries of the medium errors belonging to the mirror set 204A are deleted and the medium error table A is reduced to a medium error table B as below.

MEDIUM ERROR TABLE B

| DISK | DATA BLOCK |
|---|---|
| — | — |
| 202C | B3 |
| — | — |
| 202D | B1 |
| 202H | D1 |

Then, the CC operation proceeds to the mirror set 204B of the first row by skipping the XOR on the mirror set 204A. From the medium error table B, it is determined that there are two medium errors for the mirror set 204B. One medium error is at data block B3 of the disk 202C and other medium errors is at data block B1 of the disk 202D. Since both the medium errors of the mirror set 204B are at different data blocks, the medium errors are recoverable. Hence, the medium errors belonging to the mirror set 204B are recovered. Further, the medium error entries belonging to the mirror set 204B are deleted from the medium error table B and the medium error table B is reduced as medium error table C shown below:

MEDIUM ERROR TABLE C

| DISK | DATA BLOCK |
|---|---|
| — | — |
| — | — |
| — | — |
| — | — |
| 202H | D1 |

Then, an XOR operation is performed on the mirror set 204B. In one embodiment, during the XOR operation, if data in the mirror set 204B is not consistent, then the mirrored disk 202D is updated using data from the disk 202C. In another embodiment, if the data in the mirror set 204B is consistent, then it is determined whether a next mirror set is available in the spanned RAID 1E disk array 200A for performing the XOR operation to determine data consistency. For all subsequent mirror sets in the first row, the medium errors are determined, recovered, and corresponding medium error entries are deleted from the medium error table C. Finally, all the medium errors found during the read operation on the first row are deleted and the medium error table C becomes empty. If there are no more mirror sets in the spanned RAID 1E disk array 200A, then the CC operation is completed on the first row.

Then, the CC operation on a next row (e.g., a second row) in the spanned RAID 1E disk array 200A is performed. In one exemplary implementation, a read operation is performed on the second row. Then, medium errors belonging to the second row is found and grouped on a mirror set basis. Further, recovery of the medium errors is performed. Finally, an XOR operation is performed on the second row which is similar to the XOR operation performed on the first row as described above. Further, based on the outcome of the performed XOR operation, the mirrored disks may be updated. Likewise, performing the read operation, grouping the medium errors, recovering the medium errors, performing the XOR operation, and updating the mirrored disks are repeated until all rows in the spanned RAID 1E disk array 200A are completed.

FIG. 2B illustrates an exemplary non-spanned RAID 1E disk array 200B implementing the mirror set based medium error handling described in FIG. 1, according to one embodiment. The RAID 1E disk array 200B includes mirror sets 204I-L including disks 202Q-X. As shown in FIG. 2B, disk 202Q, disk 202R, 202S, disk 202T, disk 202U, and disk 202V have medium errors in them. The method of performing the read operation on a row by row basis, grouping the medium errors on a mirror set basis, recovering the medium errors, performing the XOR operation and updating inconsistent disks is similar to the method described with reference to FIG. 2A.

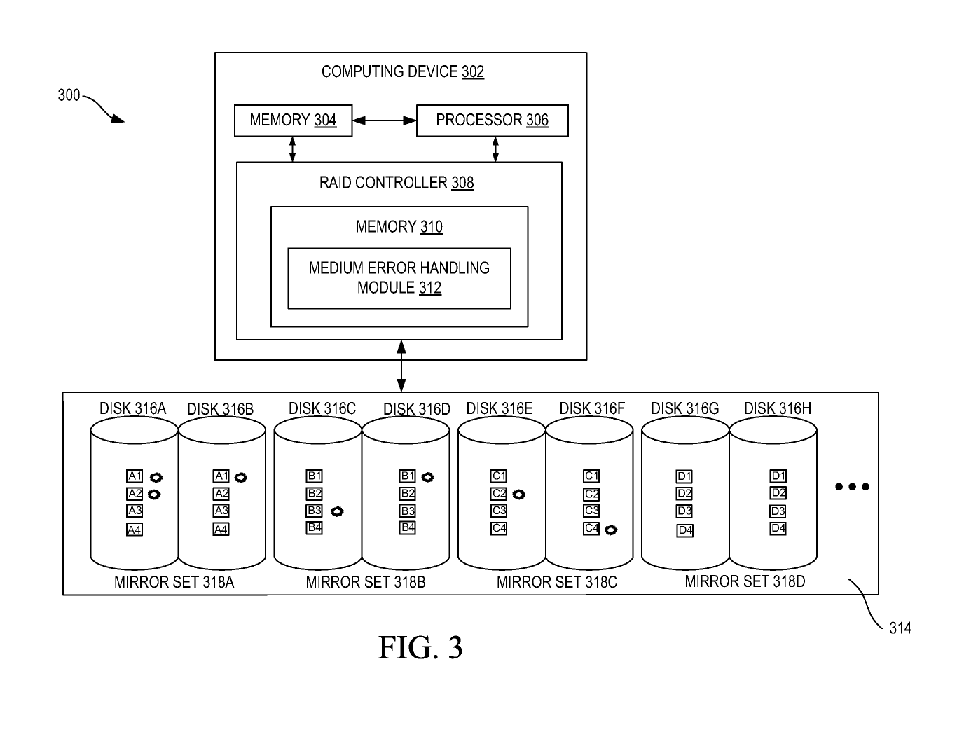

FIG. 3 illustrates an exemplary storage system 300 for implementing embodiments of the present subject matter. As shown, the storage system 300 includes a RAID 1E disk array 314. The RAID 1E disk array 314 may be a spanned RAID 1E disk array or a non-spanned RAID 1E disk array. Also, the RAID IE disk array may be in a degraded state due to missing or offline disks. The storage system 300 also includes a computing device 302 including memory 304 and a processor 306.

Further as shown, the computing device 302 includes a RAID controller 308 communicatively coupled to the RAID 1E disk array 314. According to an embodiment of the present subject matter, the RAID controller 308 includes a medium error handling module 312 stored in its memory 310 for performing the mirror set based medium error handling during a CC operation on the RAID 1E disk array 314. For example, the medium error handling module 312 may be stored in the form of instructions in the memory 310 that when executed by the computing device 302, causes the computing device 302 to perform the medium error handling during the CC operation as described in FIGS. 1, 2A and 2B. In another embodiment, the medium error handling module 312 may be stored in the form of instructions on a non-transitory computer readable storage medium that when executed by the computing device 302 causes the computing device 302 to perform the medium error handling during the CC operation as described in FIGS. 1, 2A and 2B. In various embodiments, the methods and systems described in FIGS. 1 through 3 enable handling of medium errors found during the CC operation of the RAID IE disk array. Since the read operation completes on a row by row basis, better performance is achieved during the CC operation.

Although the present embodiments have been described with reference to specific example embodiments, it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A method for performing a mirror set based medium error handling during a consistency check (CC) operation on a RAID 1E disk array, wherein the RAID 1E disk array is formed using a plurality of mirror sets having a plurality of rows, wherein each of the plurality of mirror sets includes a pair of disks, and wherein each of the plurality of rows includes at least one block in each of the pair of disks, comprising:
performing a read operation on a current row and forming a list of all medium errors found in the current row during the read operation in a first phase of the CC operation; and
grouping the medium errors found in the current row on a mirror set basis and recovering the medium errors that do not have a corresponding medium error in a substantially same block in other disk in a mirror set during a second phase of the CC operation.

2. The method of claim 1, further comprising:
performing an exclusive -OR (XOR) operation on the current row in all the plurality of mirror sets for determining data consistency between the pair of disks in each of the plurality of mirror sets; and
updating data on a mirrored disk in each of the plurality of mirror sets based on the outcome of the performed XOR operation.

3. The method of claim 2, wherein updating the data on the mirrored disk in each of the plurality of mirror sets based on the outcome of the performed XOR operation comprises:
if data is not consistent in a current mirror set, then updating the data on the mirrored disk in the current mirror set; and
if the data is consistent in the current mirror set, then determining to see whether a next mirror set is available in the RAID 1E disk array that requires performing the XOR operation to determine data consistency.

4. The method of claim 3, further comprising:
if there is a next available mirror set in the current row in the RAID 1E disk array, then performing an XOR operation on the next mirror set; and
if there is no mirror set left in the first row in the RAID 1E disk array, then completing the CC operation on the current row.

5. The method of claim 4, further comprising:
repeating the steps of performing the read operation, grouping, recovering, performing the XOR operation and updating on a next row in the RAID 1E disk array until all the rows in the RAID 1E disk array are completed.

6. The method of claim 1, wherein grouping the medium errors found in the current row on the mirror set basis and recovering the medium errors that do not have the corresponding medium error in the substantially same block in the other disk in the mirror set during the second phase of the CC operation, comprises:
determining one or more medium errors associated with a current mirror set from the list of medium errors found in the current row;
recovering the determined one or more medium errors for the current mirror set in the current row; and
repeating the steps of determining and recovering for a next mirror set in the current row of the RAID 1E disk array.

7. The method of claim 1, wherein the RAID 1E disk array comprises a spanned RAID 1 E disk array or a non-spanned RAID 1E disk array.

8. A non-transitory computer-readable storage medium for performing a mirror set based medium error handling during a CC operation on a RAID 1E disk array, wherein the RAID 1E disk array is formed using a plurality of mirror sets having a plurality of rows, wherein each of the plurality of mirror sets includes a pair of disks, and wherein each of the plurality of rows includes at least one block in each of the pair of disks, having instructions that, when executed by a computing device, cause the computing device to perform a method comprising:
performing a read operation on a current row and forming a list of all medium errors found in the current row during the read operation in a first phase of the CC operation; and
grouping the medium errors found in the current row on a mirror set basis and recovering the medium errors that do not have a corresponding medium error in a substantially same block in other disk in a mirror set during a second phase of the CC operation.

9. The non-transitory computer-readable storage medium of claim 8, further comprising:
performing an XOR operation on the current row in all the plurality of mirror sets for determining data consistency between the pair of disks in each of the plurality of mirror sets; and
updating data on a mirrored disk in each of the plurality of mirror sets based on the outcome of the performed XOR operation.

10. The non-transitory computer-readable storage medium of claim 9, wherein updating the data on the mirrored disk in each of the plurality of mirror sets based on the outcome of the performed XOR operation comprises:
if data is not consistent in a current mirror set, then updating the data on the mirrored disk in the current mirror set; and
if the data is consistent in the current mirror set, then determining to see whether a next mirror set is available in the RAID 1E disk array that requires performing the XOR operation to determine data consistency.

11. The non-transitory computer-readable storage medium of claim 10, further comprising:
if there is a next available mirror set in the current row in the RAID 1E disk array, then performing an XOR operation on the next mirror set; and
if there is no mirror set left in the first row in the RAID 1E disk array, then completing the CC operation on the current row.

12. The non-transitory computer-readable storage medium of claim 11, further comprising:
repeating the steps of performing the read operation, grouping, recovering, performing the XOR operation and updating on a next row in the RAID 1E disk array until all the rows in the RAID 1E disk array are completed.

13. The non-transitory computer-readable storage medium of claim 8, wherein grouping the medium errors found in the current row on the mirror set basis and recovering the medium errors that do not have the corresponding medium error in the substantially same block in the other disk in the mirror set during the second phase of the CC operation, comprises:
determining one or more medium errors associated with a current mirror set from the list of medium errors found in the current row;
recovering the determined one or more medium errors for the current mirror set in the current row; and
repeating the steps of determining and recovering for a next mirror set in the current row of the RAID 1E disk array.

14. A storage system, comprising:
a computing device, comprising:
a processor;
a RAID controller including memory, wherein the RAID controller is communicatively coupled to the processor; and
a RAID 1E disk array communicatively coupled to the RAID controller, wherein the RAID 1E disk array is formed using a plurality of mirror sets having a plurality of rows, wherein each of the plurality of mirror sets includes a pair of disks, wherein each of the plurality of rows includes at least one block in each of the pair disks, and wherein the RAID controller comprises a medium error handling module stored in the memory of the RAID controller in the form of instructions capable of:
performing a read operation on a current row and forming a list of all medium errors found in the current row during the read operation in a first phase of the CC operation; and
grouping the medium errors found in the current row on a mirror set basis and recovering the medium errors that do not have a corresponding medium error in a substantially same block in other disk in a mirror set during a second phase of the CC operation.

15. The storage system of claim 14, further comprising the medium error handling module having instructions capable of:
performing an XOR operation on the current row in all the plurality of mirror sets for determining data consistency between the pair of disks in each of the plurality of mirror sets; and
updating data on a mirrored disk in each of the plurality of mirror sets based on the outcome of the performed XOR operation.

16. The storage system of claim 15, wherein the medium error handling module has instructions capable of updating the data on the mirrored disk in each of the plurality of mirror sets based on the outcome of the performed XOR operation comprising:
if data is not consistent in a current mirror set, then updating the data on the mirrored disk in the current mirror set; and
if the data is consistent in the current mirror set, then determining to see whether a next mirror set is available in the RAID 1E disk array that requires performing the XOR operation to determine data consistency.

17. The storage system of claim 16, further comprising the medium error handling module having instructions capable of:
if there is a next available mirror set in the current row in the RAID 1E disk array, then performing an XOR operation on the next mirror set; and
if there is no mirror set left in the first row in the RAID 1E disk array, then completing the CC operation on the current row.

18. The storage system of claim 17, further comprising the medium error handling module having instructions capable of:
repeating the steps of performing the read operation, grouping, recovering, performing the XOR operation and updating on a next row in the RAID 1E disk array until all the rows in the RAID 1E disk array are completed.

19. The storage system of claim 14, wherein the medium error handling module has instructions capable of grouping the medium errors found in the current row on the mirror set basis and recovering the medium errors that do not have the corresponding medium error in the substantially same block in the other disk in the mirror set during the second phase of the CC operation, comprising:
determining one or more medium errors associated with a current mirror set from the list of medium errors found in the current row;
recovering the determined one or more medium errors for the current mirror set in the current row; and
repeating the steps of determining and recovering for a next mirror set in the current row of the RAID 1E disk array.

20. The storage system of claim 14, wherein the RAID 1E disk array comprises a spanned RAID 1E disk array or a non-spanned RAID 1E disk array.
